(19) United States
(12) Patent Application Publication
(10) Pub. No.: US 2009/0114405 A1
(43) Pub. Date: May 7, 2009

(54) Method and Arrangement for Fighting Fires with Compressed-Air Foam

(75) Inventors: Dirk Schmitz, Wilnsdorf (DE); Michael Rudzok, Halle (Saale) (DE); Steven Rodenhuis, Dordrecht (NL); Tino Kruger, Juterbog (DE); Gunter Dorau, Postdam (DE)

Correspondence Address: THE WEBB LAW FIRM, P.C., 700 KOPPERS BUILDING, 436 SEVENTH AVENUE, PITTSBURGH, PA, 15219, US

(73) Assignee: SOGEPI S.A., Couvet (CH)

(21) Appl. No.: 11/814,518

(22) PCT Filed: Jul. 10, 2006
(86) PCT No.: PCT/DE2006/001216

§ 371 Date: Jun. 11, 2008

(30) Foreign Application Priority Data
Nov. 7, 2005 (DE) 10 2005 053 320.5

(51) Int. Cl. A62C 31/12

(52) U.S. Cl. 169/70

(57) ABSTRACT

The invention relates to a method and an arrangement using compressed-air foam for the stationary fire fighting of burning matter of a two-dimensional or three-dimensional form, in particular in road tunnels, in which method the compressed-air foam produced by a foam generator is delivered to the extinguishing area concerned by means of a main compressed-air foam pipeline and is discharged there in a distributed manner by means of a manifold pipe system.

The invention relates to a method and an arrangement using compressed-air foam for the stationary fire fighting of burning matter of a two-dimensional or three-dimensional form, in particular in road tunnels, in which method the compressed-air foam produced by a foam generator is delivered to the extinguishing area concerned by means of a main compressed air foam line and is discharged there in a distributed manner by means of a pipe manifold system.

Foam extinguishing methods are known wherein the extinguishing foam required for fire fighting is brought directly to the source of the fire using the foam nozzle required to discharge the extinguishing agent. To produce the foam, a water-foaming agent mixture is foamed with the ambient air in or at the foam-forming nozzle. When fighting fires in road tunnels and other tunnel-like buildings or in general for extinguishing burning fuels, oils, tyres, cables, plastic material and the like, which produce a high proportion of smoke and soot particles, foaming at or in the foam nozzle presents difficulties insofar as the hot combustion gases and the smoke and soot particles conflict with the functioning of the foam nozzles and optimum foam formation. In addition, the foam thus produced only emerges from the foam nozzles at low pressure. The expansion takes place subsequently as a result of gravity. Surfaces fires and fires of structured matter thus cannot be fought effectively using conventional foam generating systems.

The use of compressed-air foam produced in a decentralised manner has already been proposed for fire-fighting in road tunnels. In this case, stable compressed-air foam is conveyed via compressed-air foam pipelines under pressure to the relevant extinguishing area of a pipe manifold system formed on the ceiling of the road tunnel and is discharged thereby by means of rotating nozzle bodies driven by the compressed air foam.

Rotating nozzles for the discharge of compressed-air foam are described, for example, in U.S. Pat. No. 6,764,024 B2 but these are not provided for use in road tunnels and are not suitable for this purpose. A stable foam for fire fighting can certainly be discharged in this manner but the discharging of the compressed-air foam using rotating nozzles is disadvantageous insofar as the foam jet which sets the nozzle in rotation decomposes in the vicinity of the nozzle and results in an almost complete reduction of the flow pressure at the nozzle. Foam can be applied to surface fires over a large circular area using the compressed-air foam thus discharged, but effective fighting of three-dimensionally configured burning matter, for example, a lorry located in a road tunnel or three-dimensionally structured burning matter, for example, a stack of wooden pallets or car tyres burning internally, is only possible to an inadequate extent since the compressed-air foam cannot reach the side and front faces of the burning matter and cannot enter right into the interior of a stack of burning matter.

It is thus the object of the invention to provide a method and a corresponding arrangement for stationary fire fighting using compressed air foam such that both surface fires and also fires of three-dimensionally configured and structured burning matter can be extinguished effectively and in a short time.

According to the invention, the object is achieved with a method according to the features of claim 1 and a nozzle arrangement according to the features of claim 5. Further features and advantageous further developments of the invention are obtained from the dependent claims.

The basic idea of the invention is that alternately obliquely directed compressed-air full jets overlapping in a cross shape are formed by means of specially configured stationary full jet nozzles disposed above the burning matter, in a plurality of rows formed by nozzle pipes on both sides, which jets propagate in opposite directions between the rows or nozzle pipes additionally as a result of an opposite inclination of the full-jet nozzles between the rows. The full-jet nozzles are additionally aligned obliquely to the horizontal plane in relation to a perpendicular starting from the nozzle rows, at different angles on both sides of the row so that the compressed-air foam full jets impinge on the burning matter at regularly distributed full-jet impact points in horizontal planes at different heights but also perpendicular side and front faces and can also penetrate into three-dimensional structured burning matter. The fire-fighting in successive extinguishing regions takes place in extinguishing intervals whereby firstly the central extinguishing region and then successively the respectively adjacent extinguishing regions are exposed to short-term compressed-air foam surfaces at high extinguishing agent intensity.

The full-jet nozzles are configured as multi-channel nozzles, in particular as two-channel or three-channel full-jet nozzles composed of two or three single full-jet nozzles directed in opposite directions at different angles on opposite sides, arranged obliquely with respect to the longitudinal axis of their connecting pipe to be connected to the nozzle pipe. The multi-channel nozzles are aligned alternately in opposite directions to the nozzle pipe to effect the cross-shaped overlap of the compressed-air foam full jets. The oppositely directed expansion of the foam is achieved by alternately oppositely directed alignment of the multi-channel full jet nozzles between neighbouring nozzle pipes. The single full-jet nozzles comprise a conical inlet portion and a cylindrical jet forming portion to form the compressed-air foam full jets.

The method according to the invention and the corresponding arrangement can be used to rapidly and effectively fight and extinguish surface fires or fires of three-dimensional or structured objects in tunnels, in particular in road tunnels.

Exemplary embodiments of the invention are explained in detail with reference to the drawings. In the figures.

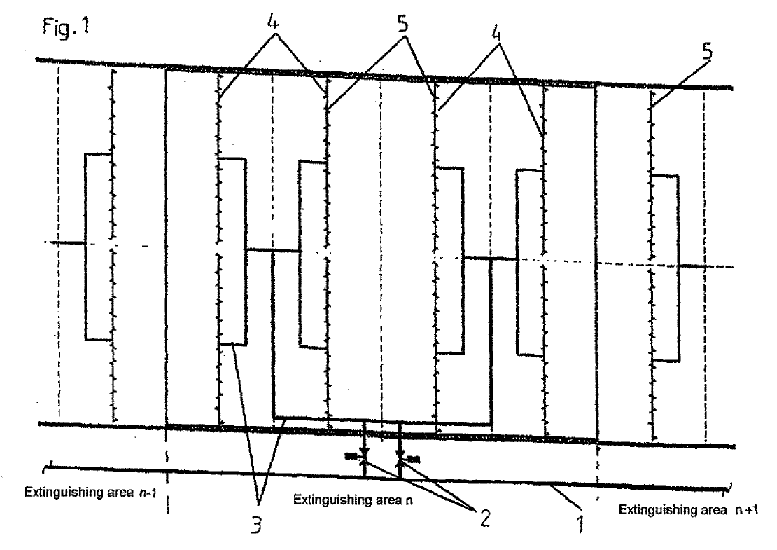

FIG. 1 is an installation scheme of a pipe system arranged on a tunnel ceiling for discharging compressed-air foam by means of full jet nozzles;

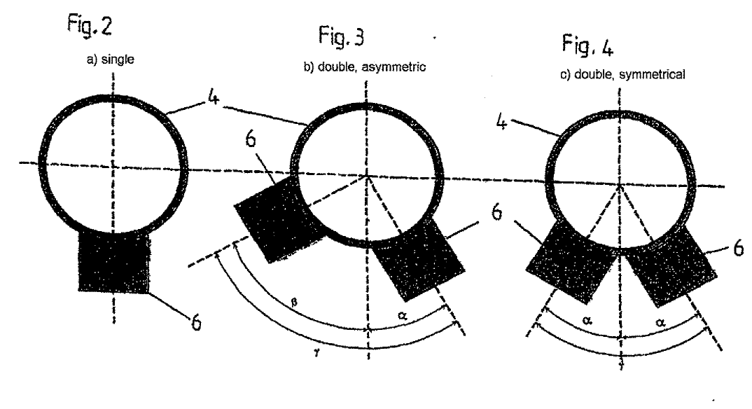

FIG. 2 is a sectional view of a nozzle pipe having coupling sleeves for full jet nozzles, directed perpendicular to the road surface;

FIG. 3 is a sectional view of a nozzle pipe having coupling sleeves arranged asymmetrically at an angle;

FIG. 4 is a sectional view of a nozzle pipe having coupling sleeves arranged symmetrically at an angle;

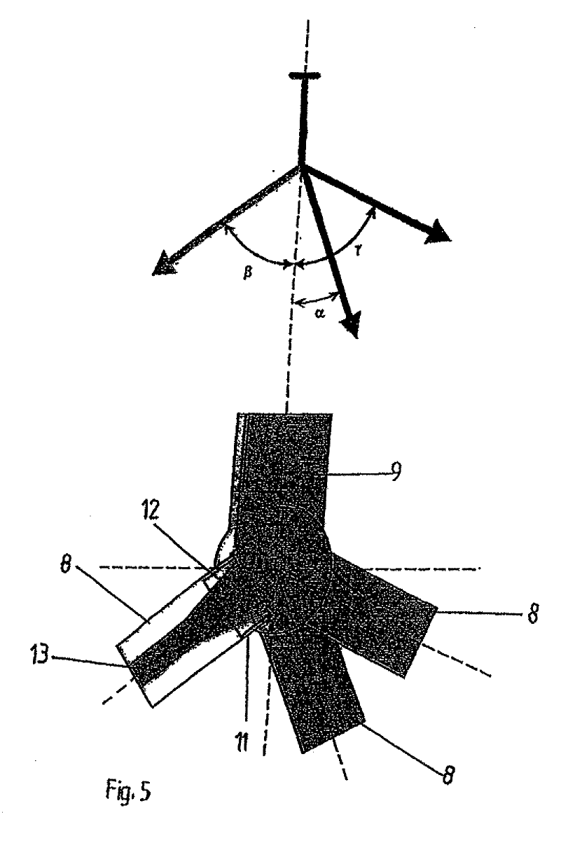

FIG. 5 is an asymmetric three-channel full-jet nozzle with three different angular positions of the single nozzles reproduced schematically,

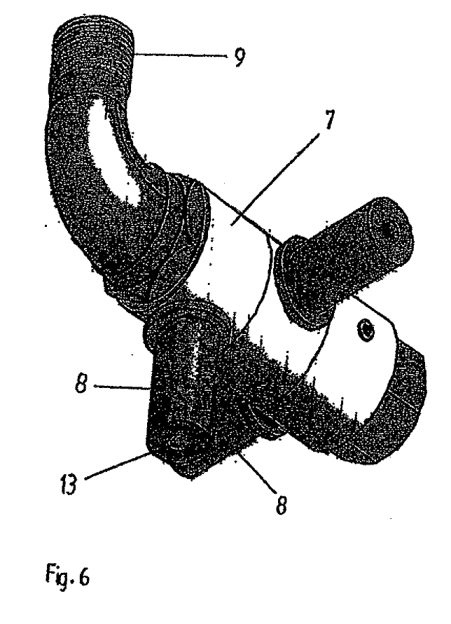

FIG. 6 is a perspective view of a three-channel full jet nozzle composed of single nozzles according to FIG. 5;

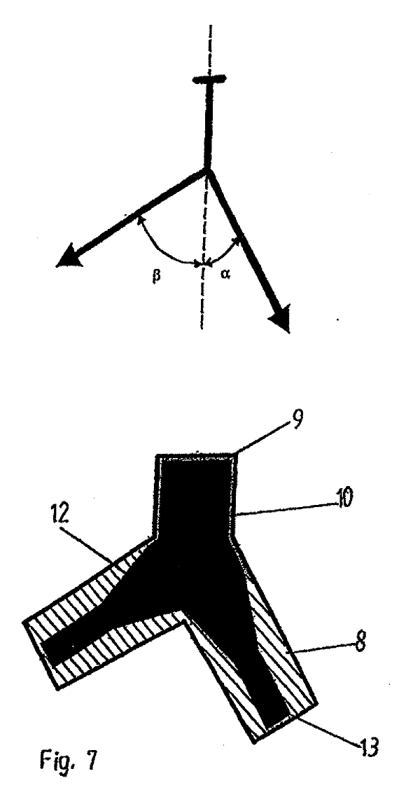

FIG. 7 is a schematic view of an asymmetric two-channel full jet nozzle (asymmetric Y-full jet nozzle) formed in one piece together with a diagram of the angular positions of the single nozzles;

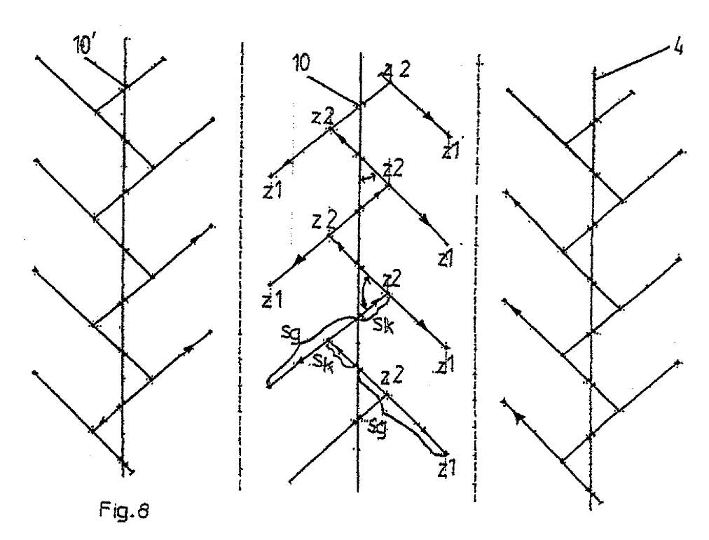

FIG. 8 is a partial view of an extinguishing area with asymmetric two-channel full jet nozzles attached to the nozzle pipes in opposite directions in each case at an angle of 45° according to FIG. 7 and intersecting compressed-air foam full jets;

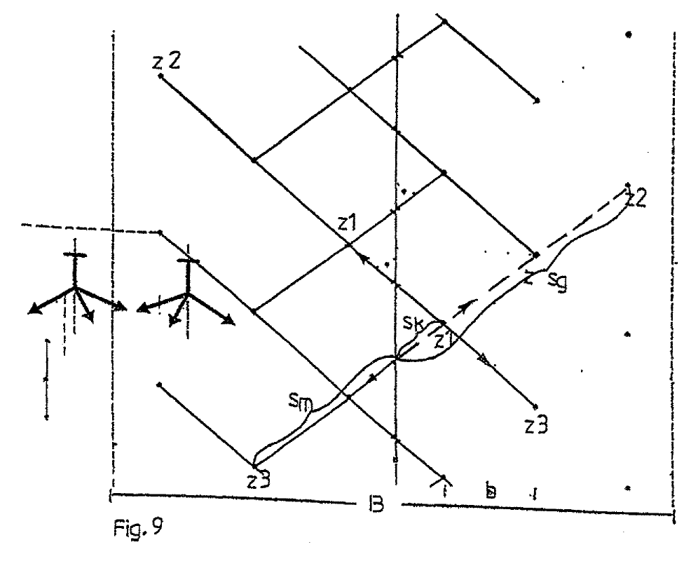

FIG. 9 is a partial view of a nozzle pipe with asymmetric three-channel full jet nozzles attached to said pipe alternately in opposite directions at an angle of 45° according to FIG. 5; and

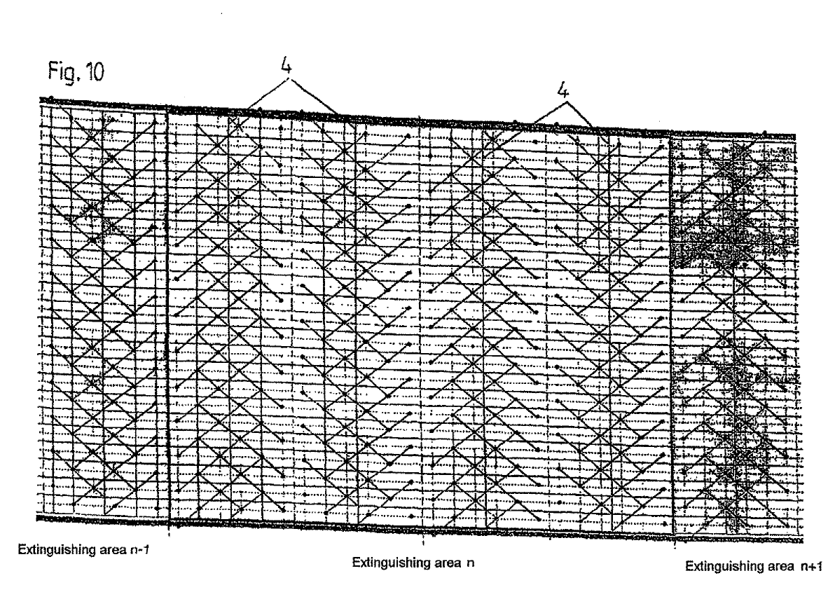

FIG. 10 is a distribution diagram of the compressed-air foam full jets in an extinguishing region with four nozzle pipes fitted with asymmetric three-channel full-jet nozzles.

The installation scheme shown in FIG. 1 comprises a main compressed-air foam pipeline 1 via which the compressed-air foam is guided from a decentralised compressed-air foam generating system (not shown) to—redundant—extinguishing area valves 2 provided in the relevant extinguishing area n and from these, via a symmetrically designed pipe manifold system 3 into the symmetrically arranged nozzle pipes 4 installed in the extinguishing area n on the tunnel ceiling or above the road surface and transversely to its longitudinal direction. To ensure symmetry, the number of nozzle pipes corresponds to the power of the number “two”. Incorporated in the nozzle pipes 4 are compressed-air foam full-jet nozzles 5, which are fixedly arranged at a regular spacing and in a specific angular position and are directed onto the road surface, and which can be configured as single-, two- or multi-jet nozzles, in such a manner that uniform surface foaming takes place in various horizontal planes, for example, roof surfaces of lorries, small transporters and cars or the road surface as well as in vertical planes, such as for example, side and front surfaces of lorries.

The pipelines are dimensioned so that the foam flow lies in the “small bubble” regime for two-phase flows and a certain critical flow velocity which would destroy the foam bubbles is not exceeded.

As shown in FIGS. 2 to 4, coupling sleeves 6 are provided on the nozzle pipes 6 positioned in various angular positions. Whereas coupling sleeves 6 directed only perpendicularly to the road surface are formed on the nozzle pipe 4 according to FIG. 2, FIGS. 3 and 4 show coupling sleeves 6 aligned asymmetrically or symmetrically at an angle. According to the angular position (α, β) of the coupling sleeves 6, the compressed-air foam can be deposited in various tunnel planes or surface regions or thrown onto perpendicular surfaces using the full-jet nozzles connected to the coupling sleeves.

In the case of the multi-part asymmetric three-channel full-jet nozzle 7 (tri-full jet nozzle) shown schematically and in perspective view in FIGS. 5 and 6, the nozzle body comprises three single full-jet nozzles 8 set in different angular positions α, β, γ with respect to the road surface in the extinguishing area n of the road tunnel and a connection pipe 9 which is screwed into the coupling sleeve 6 of the nozzle pipe 4.

FIG. 7 shows an asymmetric two-channel full-jet nozzle 10 executed in one piece as a cast or welded body, consisting of two successively arranged single full-jet nozzles 8 aligned at different angles α, β from the perpendicular and a connection pipe 9. The two-channel full-jet nozzle can also be configured as a symmetrical two-channel full-jet nozzle (symmetrical Y-full jet nozzle) with single full-jet nozzles 8 arranged in a symmetrical angular position. In this case, the slope of the full jet can be effected by means of a coupling sleeve arranged at an angle. Naturally, the asymmetric three-channel full-jet nozzle 7 shown in FIGS. 5 and 6 can also be implemented as a one-piece cast or welded nozzle body. The single nozzles 8 with connecting thread 11 which can be seen in particular in FIGS. 5 and 6 can be screwed individually into the coupling sleeve 6 and thus function as a single full-jet nozzle 8.

Each single full-jet nozzle 8 consists of a conical inlet portion 12 and an elongated jet forming cylinder 13 adjacent thereto on its tapering side for forming and guiding the compressed-air foam full jet. Depending on the amount of compressed-air foam to be discharged and the number of single full-jet nozzles 8, the diameter of the jet forming cylinder is such that the dynamic flow pressure at the nozzle is 1.0 to 1.5 bar and with every single full jet nozzle arranged at a height of 5 m and at an angle of 45°, a range of throw of 8 m and a foam carpet having a size between 3 and 5 m² is formed when the full jet impinges on a horizontal surface.

The single full-jet nozzles 8 of the two-channel and three-channel full jet nozzles 7, 10 are aligned at a different inclination (α, β, γ: FIGS. 5, 7) which can be further varied by coupling sleeves 6 arranged obliquely (FIGS. 2 to 4) on the nozzle pipes 4 so that each single full-jet nozzle 8 can cover the surface of a different horizontal surface area of the road surface or vehicle roofs located at different heights with compressed-air foam. As a result of the inclined arrangement of the single full-jet nozzles 8, perpendicular side surfaces of the burning matter are also acted upon with compressed-air foam and specifically not only side surfaces running substantially parallel to the nozzle pipes 4 or perpendicular to the road surface but also side surfaces aligned substantially in the longitudinal direction of the road surface. The coverage of all side surfaces is ensured by alternately aligning as a whole, the two- or three-channel full jet nozzles 7, 10 attached to the respective nozzle pipe 4 alternately at an angle of 45° relative to the longitudinal axis of the nozzle pipes 4. The alternating angular arrangement from one nozzle body to another relative to the longitudinal axis of the nozzle pipes 4 can be seen from FIG. 1. The single full-jet nozzles 8 are therefore not only obliquely aligned with respect to the road surface but also obliquely aligned in the direction of the tunnel side walls so that not only the front faces but also the side surfaces of the burning matter are covered. The oblique alignment of the single full jet nozzles 8 and the impinging of the compressed-air foam full-jet nozzles onto the substantially perpendicular side surfaces of three-dimensionally structured burning matter thereby effected additionally has the advantages that the compressed-air foam can penetrate into the interior of a structured burning matter and thus highly effective fire fighting is ensured.

FIG. 8 shows a section of the extinguishing area n shown in FIG. 1 with nozzle pipes 4 to which asymmetric two-channel full-jet nozzle 10 are connected, at an angle of 45° relative to the longitudinal axis of the respective nozzle pipe alternately in one direction and in the other direction. That is to say, two-channel full-jet nozzles 10 arranged adjacently on the same nozzle pipe 4 are arranged at an angle of 90° with respect to one another relative to the longitudinal axis so that the direction of ejection of adjacent two-channel full jet nozzle 10 intersects and their different ejection width s_{g} and sₖ produced by the different inclination (asymmetry) of the single full jet nozzles 8 at the angle α, β differs alternately on one side and on the other. The centre of the respective compressed-air foam area, that is the full jet impact point is designed by z₁ and z₂. As a result, two parallel rows of full jet impact points z1 and z2 arranged at a uniform is distance longitudinally and transversely to the tunnel road surface are obtained on both sides of the nozzle pipe 4. It is also clear from FIG. 8 that the asymmetric two-channel full-jet nozzle 10′ arranged at the same height on the respectively adjacent nozzle pipe 4 is turned through 180° with respect to the two-channel full-jet nozzle 10 in order to thus achieve an oppositely directed expansion of foam and closed coverage of compressed-air foam as far as possible.

In the partial view of a nozzle pipe 4 shown in FIG. 9 with asymmetric three-channel full-jet nozzles 7 according to FIG. 5 arranged obliquely thereon at an angle φ=45°, a small and a large width of throw (sk, sg) is achieved with the two single full-jet nozzles 8 directed to one side and a medium width of throw (sm) is achieved with the single full-jet nozzle 8 directed to the other side. The adjacent three-channel full-jet nozzle 7 in the same nozzle row 4 is turned through 90° so that the widths and directions of throw of adjacent three-channel full-jet nozzles 7 in one nozzle row are each reversed. As has already been explained in FIG. 8, in this case also, the three-channel full-jet nozzles located at the same height on the respectively adjacent nozzle pipe are also turned through 180° into the opposite direction (not shown), In the area of a nozzle pipe 4 respectively three rows of full jet impact points z1, z2 and z3, distributed over a width “B” and at the same distance “b”, are obtained parallel to and on both sides of said nozzle pipe.

The alternately oppositely directed alignment of the two- or three-channel full jet s nozzles 10, 7 explained with reference to FIGS. 8 and 9 results in a cross-shaped coverage of the full-foam jets of the respective nozzle pipe. The oppositely directed alignment of the full jet nozzles from one nozzle pipe to another, which can also be seen from FIG. 8 in particular, ensures that the foam expands in opposite directions. Uniform, surface-covering foaming of flats surfaces, including those located at different heights, is thus ensured. The oblique position of the single full-jet nozzles and therefore compressed-air foam full jets also ensures that vertical surfaces of three-dimensional burning matter can also be acted upon with compressed-air foam. The angle of incidence α, β, γ of the single full-jet nozzles 8 to the perpendicular depends on the distance between the nozzle pipes 4, that is the required width of throw sk, sg, sm and also determines the capacity for penetration into structured burning matter.

For the example of a road tunnel, FIG. 10 shows a foaming scheme for an extinguishing area n with four nozzle pipes 4 and three-channel full-jet nozzles 7 attached thereto according to the description of FIG. 4. The thickness of the compressed-air foam frill jets and the uniform distribution of the compressed-air foam in the extinguishing area is determined by the number of nozzle pipes 4 and compressed-air foam full-jet nozzles, in this case the three-channel full jet nozzles 7, per unit surface area. The maximum number of nozzles is obtained, however, from the available total volume of the foam generators. The diagram clearly shows the uniform distribution of the full jet impact points over the entire extinguishing area and the cross-shaped coverage of the full foam jets.

The extinguishing process is conducted in the central extinguishing area n and the two respectively adjacent extinguishing areas n+1 and n+2 as well as n−1 and n−2 at intervals related to the individual extinguishing areas, whereby initially the central extinguishing area, thereafter the two adjacent extinguishing areas and then the outer extinguishing areas are each briefly acted upon with a quantity of compressed-air foam far above the normal application rate. That is, surges of compressed air foam having a very high foam intensity are produced successively in each extinguishing area. This extinguishing cycle is repeated many times whereby the total cycle time and therefore the duration of the individual cycles in the respective extinguishing areas are gradually increased and at the end, can be twice as high as at the beginning of the extinguishing process. The extinguishing at intervals using compressed air foam full jets and high-intensity extinguishing agent ensures rapid surface-covering foaming and a high depth of penetration of the compressed air foam and thus efficient, short-term and reliable extinguishing, especially of solid and glow-forming materials and materials present in a three-dimensional structured arrangement. At the same time, the consumption of compressed-air foam over the entire extinguishing time is no higher than for continuous extinguishing at a low application rate.

### REFERENCE LIST

1 Main compressed-air foam pipeline

2 Redundant extinguishing area valves

3 Pipe manifold system

4 Nozzle pipes

5 Compressed-air foam full jet nozzles

6 Coupling sleeves

7 Asymmetric three-channel full-jet nozzles

8 Single full-jet nozzle

9 Connecting pipes of 7, 10

10 Asymmetric two-channel full-jet nozzles

11 Connecting thread of 8 (for multi-part full-jet nozzles)

12 Conical inlet portion of 8

13 Jet forming cylinder of 8

Z1 to Z3 Full jet impact points

S_{g} Large width of throw

Sₖ Small width of throw

Sₘ Medium width of throw

α, β, γ Angle of inclination of 8 (angle of inclination of 6)

φ Angle of inclination of 7, 10

1-12. (canceled)

13. A method for using compressed-air foam for the stationary fire fighting of burning matter of a two-dimensional or three-dimensional form, wherein the method comprises the steps of;
delivering the compressed-air foam produced by a foam generator to an extinguishing area via a main compressed air foam line;
discharging the compressed-air foam at the extinguishing area in a distributed manner via a pipe manifold system;
positioning a plurality of compressed-air foam full jets starting from the pipe manifold system, wherein the jets have a predefined flow pressure, are overlapping in a cross shape in a respective row and propagating in opposite directions between neighbouring rows, wherein each jet is a multi-channel nozzle, wherein the channels thereof are directed (a) in opposite directions at different angles to opposite sides, above the burning matter in a plurality of rows spaced uniformly apart in a transverse direction to the extinguishing area on both sides, or (b) obliquely directed at an angle (φ);
directing the jets onto the burning matter at a different angle (α, β, γ) deviating from the perpendicular; and
applying the compressed-air foam at uniformly spaced fl-jet impact points (z1 to z3) on horizontal surfaces of the burning matter at different heights and on perpendicular and front faces of three-dimensionally configured burning matter; or
introducing the compressed-air foam into two-dimensionally structured burning matter.

14. The method according to claim 13, wherein the compressed-air foam full jets respectively comprise:
one jet on both sides; or
one jet on one side and two jets on the other side, wherein each jet is positioned at a different angle (α, β, γ) to the perpendicular.

15. The method according to claim 14, further comprising the step of positioning the compressed-air foam full jets successively at intervals in a plurality of adjacent extinguishing regions, wherein time-limited compressed-air foam surges include a large quantity of extinguishing agent, wherein in a plurality of successive extinguishing cycles, initially, the central extinguishing region (n) and then the two first (n+1, n−1) and then the two second (n+2, n−2) extinguishing regions are supplied with the compressed-air foam.

16. The method according to claim 15, wherein the extinguishing cycles are lengthened with increasing cycle number while the intensity of the extinguishing agent is reduced.

17. An arrangement for using compressed-air foam for the stationary fire fighting of burning matter of a two-dimensional or three-dimensional form, comprising:
a plurality of successive extinguishing regions (n, n+1, n−1 etc.) defined in a longitudinal direction; and
a pipe manifold system situated in each region, wherein each pipe manifold system is connected via extinguishing-region valves to a main compressed-air foam pipeline, wherein nozzle pipes disposed on the pipe manifold system are symmetrically transversely to the longitudinal direction of the extinguishing regions and at a substantial uniform distance apart are connected to multi-channel full-jet nozzles comprised of single full-jet nozzles incorporated therein over their overall length at uniform distance apart by coupling sleeves, wherein the single full-jet nozzles are obliquely arranged at an angle of inclination (α, β, γ) with respect to the longitudinal axis of their connection pieces and the multi-channel full-jet nozzles are incorporated in one and the same nozzle pipe at an angle (φ) to the longitudinal direction of the nozzle pipe, and wherein the multi-channel full-jet nozzles each arranged at the same height are configured to be aligned in opposite directions to achieve an oppositely directed expansion of foam between the nozzle pipes in the respectively adjacent nozzle pipe.

18. The arrangement according to claim 17, wherein the multi-channel Full-jet nozzles include a connection pipe adapted to be screwed into the coupling sleeve of the nozzle pipe, and wherein the single full-jet nozzles comprise a conical inlet portion and all adjoining jet forming cylinder dimensioned such that a dynamic flow pressure of 1.0 to 1.5 bar is established.

19. The arrangement according to claim 18, wherein in order to form symmetrical or asymmetric two-channel full-jet nozzles, single full-jet nozzles branch off from the connecting pipe from opposite sides at a different or the same angle of inclination (α, β) to the longitudinal axis of the connection pipe.

20. The arrangement according to claim 18, wherein in order to form asymmetric three-channel fall-jet nozzles, two single full-jet nozzles branch off from the connecting pipe on one side and an opposite side thereof at different angles (α, β, γ) to the longitudinal axis of the connection pipe.

21. The arrangement according to claim 19, wherein the angle of inclination (α, β, γ) of the single full-jet nozzles is between 0° and 75°.

22. The arrangement according to claim 20, wherein the angle of inclination (α, β, γ) of the single full-jet nozzles is between 0° and 75°.

23. The arrangement according to claim 17, wherein the angle of inclination (φ) at which the multichannel full-jet nozzles are set to the longitudinal axis of the respective nozzle pipe in opposite directions is 45°.

24. The arrangement according to claim 17, wherein a single row of perpendicular coupling sleeves or two rows with coupling sleeves arranged at an angle (γ) with respect to one another is/are formed on the nozzle pipes, wherein the two rows of coupling sleeves are aligned at a different angle (α, β).

25. The arrangement according to claim 17, wherein the multi-channel full-jet nozzles are constructed as one-piece welded or cast parts.
